(19) United States
(12) Patent Application Publication
(10) Pub. No.: US 2001/0036208 A1
(43) Pub. Date: Nov. 1, 2001

(54) Intra-cavity sub-resonator frequency conversion device for generating continuous-wave high order harmonic laser light

(76) Inventors: Fuzheng Zhou, Fremont, CA (US); Chung-Po Huang, Santa Clara, CA (US); Liyue Mu, Santa Clara, CA (US)

Correspondence Address: Chien-Wei (Chris) Chou, Esq., OPPENHEIMER WOLFF & DONNELLY LLP, 1400 Page Mill Road, Palo Alto, CA, 94304, US

(21) Appl. No.: 09/802,041

(22) Filed: Mar. 7, 2001

Related U.S. Application Data
(60) Provisional application No. 60/187,570, filed on Mar. 7, 2000.

(51) Int. Cl. H01S 3/10

(52) U.S. Cl. 372/21; 372/32

(57) ABSTRACT

This invention relates to improving the low frequency laser light conversion efficiency by implementing a focusing device to increase the power density inside a non-linear medium and a sub-resonator that resonates both a second harmonic light and a third or higher harmonic light. A wave front compensation device is designed for this invention. The wave front compensation device compensates part of the wave front distortion, which is caused by the sub-cavity when the focused fundamental laser beam passes through.

### BACKGROUND OF THE INVENTION

It is a well-known technique to generate ultra-violet (UV) laser light by frequency converting lower frequency laser light using a nonlinear medium. This process requires high peak optical power density to yield reasonable efficiency. Due to its low optical power density, it is very difficult to gain reasonable conversion efficiency from a continuous-wave (CW) laser using the frequency conversion technique.

U.S. Pat. No. 5,278,852 describes a high efficiency frequency conversion laser design which comprises a sub-resonator inside the laser resonator. The sub-resonator is designed only for the second harmonic laser light to enhance the conversion efficiency. However, there are two factors this design fails to address that prevent this design from efficiently converting CW laser light into its third or higher harmonic laser light. First, there is no focusing device in this design to increase the power density. With its lower optical power, CW laser light needs to be focused to a small spot inside a non-linear medium to increase the optical power density. As a result, the conversion efficiency will also be increase. Second, the conversion efficiency can be further increased if the sub-resonator is also designed for the third or higher harmonic light. Therefore, the sub-resonator mirror that is disposed between the second harmonic non-linear medium and the laser medium needs to have a coating, which reflects both the second harmonic laser light and the third or higher harmonic laser light.

### SUMMARY OF INVENTION

This invention improves the conversion efficiency significantly by implementing a focusing device to increase the power density inside the non-linear medium and a sub-resonator that resonates both the second harmonic light and the third or higher harmonic light. In addition to the two new features, a wave front compensation device is also designed for this invention. The wave front compensation device will compensate for part of the wave front distortion, which is caused by the sub-cavity when the focused fundamental laser beam passes through.

Briefly, the preferred embodiment is a frequency conversion laser, including a fundamental wave resonator, for generating the findamental wave, having at least two mirrors to define the resonator, a laser medium, an energy source to sustain the oscillation of the resonator; and a focusing device to form a small beam waist; a second harmonic nonlinear medium to convert the fundamental wave to a second harmonic wave, and a third (or fourth) harmonic nonlinear medium to generate third (or fourth) harmonic wave; a sub-resonator, which is located partially or totally inside the findamental wave resonator, having two end mirrors, and sustaining the oscillation of both the second harmonic and the third (or forth) harmonic wave, means for allowing the second harmonic wave or both the first converted wave and the fundamental wave to enter the sub-resonator or generated inside the sub-resonator while preventing the second harmonic wave from leaving the sub-resonator; a third (or fourth) harmonic nonlinear medium located in the sub-resonator for generating the third (or fourth) harmonic wave; and means for allowing the third (or forth) harmonic wave to transmit out of the apparatus

### DESCRIPTION OF THE DRAWINGS

FIG. 1 illustrates the first embodiment of the disclosed apparatus.

FIG. 2 illustrates the second embodiment of the disclosed apparatus.

### DESCRIPTION OF THE PREFERRED EMBODIMENT

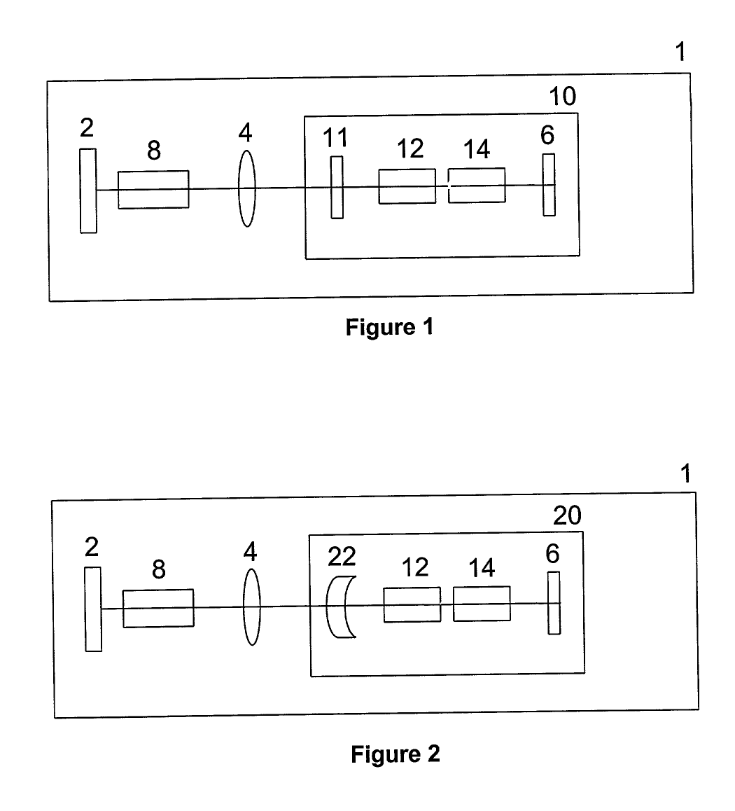

FIG. 1 shows the configuration of the first of the preferred embodiments. The fundamental wave resonator 1 comprises two end mirrors 2 and 6, the laser medium 8 and the focusing device 4. The resonator is designed to have only one waist, which is located at the surface of the end mirror 6. The sub-resonator 10 comprises one end mirror 11, the second harmonic nonlinear medium 12, the third (or forth) harmonic nonlinear medium 14, and shares the other end mirror 6 with the fundamental resonator. The end mirror 2 has a high reflection (HR) coating for the fundamental wave. The focusing device 4 has high transmission (HT) coatings for the fundamental wave on every interface. The sub-resonator end mirror 11 has a HT coating for the fundamental wave on the side facing the focusing device and a coating that is HR for both the second harmonic and third (or forth) harmonic wave and HT for fundamental wave. The shared end mirror 6 has a coating that is HR for the fundamental and second harmonic wave and HT for the third (or forth) harmonic wave. The third (or forth) harmonic nonlinear medium 14 is disposed closely to the shared end mirror 6. The second harmonic nonlinear medium 12 is positioned right next to the third (or forth) harmonic nonlinear medium 14. Both media have coatings that are HT for all the waves inside the sub-resonator.

The fundamental wave is focused by the focusing device and forms a narrow beam inside the second harmonic nonlinear medium 12 and the third (or forth) harmonic nonlinear medium 14. Inside the second harmonic nonlinear medium 12, a portion of the fundamental wave is converted into the second harmonic wave. The residual fundamental wave and the second harmonic wave then enter the third (or forth) harmonic nonlinear medium 14 and part of them is converted into the third (or forth) harmonic wave. When the three waves hit the end mirror 6, most of the third (or forth) harmonic wave will pass through while the other two waves are reflected back into the third (or forth) harmonic nonlinear medium 14. More third (or forth) harmonic wave is generated again inside the third (or forth) harmonic nonlinear medium 14. The three waves then enter the second harmonic nonlinear medium 12, where more fundamental wave is converted into the second harmonic wave. When the three waves hit the sub-resonator end mirror 11, most of fundamental wave will pass through and be amplified by the laser medium 8. The other two waves are reflected back into the sub-resonator and are oscillating inside the sub-resonator.

For the second harmonic wave the sub-resonator 10 is a balanced resonator where the rate that the second harmonics is generated is equal to the rate that the second harmonic wave is converted to the third (or forth) harmonic wave. However, for the third (or forth) harmonic wave, the sub-resonator is a high loss resonator due to the high transmission rate on the shared end mirror 6.

The positions of the two nonlinear media are arranged so that they are mostly within the depth of focus of the focusing device where the laser beam is close to collimation. However, there is no space for the sub-resonator end mirror 11 to be positioned within the depth of focus. Consequently, the sub-resonator end mirror 11 will cause wave front distortion every time the beam passes through it. This will result in lower optical power for the fundamental wave resonator. The second preferred embodiment is designed to correct this problem.

The second preferred embodiment, which implements the wave front compensation, is illustrated in FIG. 2. The fundamental wave resonator 1 comprises two end mirrors 2 and 6, the laser medium 8 and the focusing device 4. The resonator is designed to have only one waist, which is located at the surface of the end mirror 6. The sub-resonator 10 comprises one end mirror 22, the second harmonic nonlinear medium 12, the third (or forth) harmonic nonlinear medium 14, and shares the other end mirror 6 with the fundamental resonator. The end mirror 2 has a high reflection (HR) coating for the fundamental wave. The focusing device 4 has high transmission (HT) coatings for the fundamental wave on every interface. The sub-resonator end mirror 22 has a HT coating for the fundamental wave on the side facing the focusing device and, on the other side, a coating that is HR for both the second harmonic and third (or forth) harmonic wave and HT for fundamental wave. The shared end mirror 6 has a coating that is HR for the fundamental and second harmonic wave and HT for the third (or forth) harmonic wave. The third (or forth) harmonic nonlinear medium 14 is disposed closely to the shared end mirror 6. The second harmonic nonlinear medium 12 is positioned right next to the third (or forth) harmonic nonlinear medium 14. Both media have coatings that are HT for all the waves inside the sub-resonator.

The fundamental wave is focused by the focusing device and forms a narrow beam inside the second harmonic nonlinear medium 12 and the third (or forth) harmonic nonlinear medium 14. Inside the second harmonic nonlinear medium 12, a portion of the fundamental wave is converted into the second harmonic wave. The residual fundamental wave and the second harmonic wave then enter the third (or forth) harmonic nonlinear medium 14 and part of them is converted into the third (or forth) harmonic wave. When the three waves hit the end mirror 6, most of the third (or forth) harmonic wave will pass through while the other two waves are reflected back into the third (or forth) harmonic nonlinear medium 14. More third (or forth) harmonic wave is generated again inside the third (or forth) harmonic nonlinear medium 14. The three waves then enter the second harmonic nonlinear medium 12, where a portion of the fundamental wave is converted into the second harmonic wave. When the three waves hit the sub-resonator end mirror 22, most of fundamental wave will pass through and be amplified by the laser medium 8. The other two waves are reflected back into the sub-resonator and are oscillating inside the sub-resonator. The positions of the two nonlinear media, 12 and 14, are arranged so that they are mostly within the depth of focus of the focusing device where is laser beam is close to collimation.

The substrate of the sub-resonator end mirror 22 is designed to have two concentric spherical surfaces whose curvature matches the wave front of the focused fundamental beam. Therefore, the focused fundamental wave front can pass through the mirror substrate without being disturbed. Furthermore, the concave sub-resonator end mirror 22 and the flat shared end mirror 6, which is located at the center of curvature of the concave surface, constitute a stable resonator configuration. As a result, both the fundamental resonator 1 and the sub-resonator 20 will be more stable and more efficient.

The forgoing description of the preferred embodiments of the invention has been presented for the purposes of illustration and description. It is not intended to be exhaustive or to limit the invention to the precise forms disclosed. Many modifications and variations are possible in light of the above teaching. It is intended that the scope of the invention be limited not by this detailed description, but rather by the claims appended hereto

What is claimed is:

1. An apparatus for converting a laser frequency, comprising:
a) a fundamental wave resonator for generating a fundamental wave, including at least two mirrors to define said resonator, a laser medium and an energy source for providing oscillation of the resonator, and a focusing device to form a small beam waist;
b) a sub-resonator located inside said fundamental wave resonator having two end-mirrors, for providing oscillation of a second harmonic wave and a third harmonic wave;
c) a harmonic nonlinear medium to convert said fundamental wave to said second harmonic wave, and a second harmonic nonlinear medium located in said sub-resonator for generating said third harmonic wave;
d) means for allowing said second harmonic wave to enter said sub-resonator while preventing said second harmonic wave from leaving said sub-resonator; and
e) means allowing said third harmonic wave to transmit out of the apparatus.

2. The apparatus as recited in claim 1, further comprising a second sub-resonator for providing oscillation for said third harmonic wave, wherein said second sub-resonator is positioned in said first sub-resonator.

3. The apparatus as recited in claim 1, wherein said fundamental wave resonator and said sub-resonator share one end mirror.

4. The apparatus as recited in claim 1, wherein said sub-resonator is located entirely inside said findamental wave resonator.

5. The apparatus as recited in claim 1, wherein said sub-resonator is located partially inside said fundamental wave resonator.

6. The apparatus as recited in claim 1, wherein said sub-resonator having a wave-front compensation device to compensate for wave front distortion caused by focusing beam passing through optical materials.

7. The apparatus as recited in claim 6, wherein said sub-resonator having a wave front compensation device serving as an end-mirror of said sub-resonator.

8. The apparatus as recited in claim 1, wherein said sub-resonator having at least one concave end-mirror.

9. The apparatus as recited in claim 1, wherein a modulator is disposed inside said fundamental wave resonator.

10. An apparatus for converting a laser frequency, comprising:
f) a fundamental wave resonator for generating a fundamental wave, including at least two mirrors to define said resonator, a laser medium and an energy source for providing oscillation of the resonator, and a focusing device to form a small beam waist;
g) a sub-resonator located inside said findamental wave resonator having two end-mirrors, for providing oscillation of a second harmonic wave and a third harmonic wave;
h) a harmonic nonlinear medium to convert said fundamental wave to said second harmonic wave, and a second harmonic nonlinear medium located in said sub-resonator for generating said third harmonic wave;
i) means for allowing said fundamental wave to enter said sub-resonator while preventing said fundamental wave from leaving said sub-resonator; and
j) means allowing said third harmonic wave to transmit out of the apparatus.

11. The apparatus as recited in claim 10, further comprising a second sub-resonator for providing oscillation for said third harmonic wave, wherein said second sub-resonator is positioned in said first sub-resonator.

12. The apparatus as recited in claim 10, wherein said fundamental wave resonator and said sub-resonator share one end mirror.

13. The apparatus as recited in claim 10, wherein said sub-resonator is located entirely inside said findamental wave resonator.

14. The apparatus as recited in claim 10, wherein said sub-resonator is located partially inside said fundamental wave resonator.

15. The apparatus as recited in claim 10, wherein said sub-resonator having a wave-front compensation device to compensate for the wave front distortion caused by focusing beam passing through optical materials.

16. The apparatus as recited in claim 15, wherein the sub-resonator having a wave front compensation device serving as an end-mirror of said sub-resonator.

17. The apparatus as recited in claim 10, wherein said sub-resonator having at least one concave end-mirror.

18. The apparatus as recited in claim 10, wherein said modulator is disposed inside the fundamental wave resonator.
